(19) United States
(12) Patent Application Publication
(10) Pub. No.: US 2018/0268334 A1
(43) Pub. Date: Sep. 20, 2018

(54) METHOD AND DEVICE FOR MEASURING DIGITAL MATURITY OF ORGANIZATIONS

(71) Applicant: Wipro Limited, Bangalore (IN)

(72) Inventors: Devarshi Vajpayee, Bangalore (IN); Manjunatha Gk, Bangalore (IN)

(73) Assignee: Wipro Limited

(21) Appl. No.: 15/464,605

(22) Filed: Mar. 21, 2017

(30) Foreign Application Priority Data
Mar. 17, 2017 (IN) 201741009440

(51) Int. Cl. G06Q 10/06

(52) U.S. Cl. CPC G06Q 10/0637

(57) ABSTRACT

Method and device for determining digital maturity of organizations is disclosed. The method includes extracting, by a computing device, a plurality of digital maturity parameters. The method further includes creating, by the computing device, a plurality of digital fitness metrics along a plurality of digital dimensions using the plurality of digital maturity parameters. The method includes assigning, by the computing device, a weight to each the plurality of digital maturity parameters across at least one of the plurality of digital dimensions. The method further includes computing, by the computing device, a plurality of dimension scores for the plurality of digital dimensions based on the weight assigned to each of the plurality of digital maturity parameters. The method includes computing, by the computing device, a digital fitness score for the organization based on the plurality of dimension scores.

### TECHNICAL FIELD

This disclosure relates generally to digital maturity of organizations and more particularly to method and device for measuring digital maturity of organizations.

### BACKGROUND

The digital revolution has attracted many organizations to digitize in order to become more efficient. To achieve this, organizations have to first determine and understand theft current digital maturity status. This enables organizations to identify existing gaps that need to be bridged in order to lay down a roadmap to achieve desired digital maturity. However, no metric system or evaluation engine exists, which can quantitatively provide the means for organizations to accurately analyze their digital maturity with ease.

Conventional systems measure the digital maturity at an individual process or unit level and thus fail to provide a holistic measure of organization's digital fitness and its impact on the organization's revenue, operational efficiencies, and/or profits. Moreover, the conventional systems are based on restricted parameter evaluation model, which is limited to a particular type of industry and is not suitable for all industries.

### SUMMARY

In one embodiment, a method for determining digital maturity of an organization. The method includes extracting, by a computing device, a plurality of digital maturity parameters; creating, by the computing device, a plurality of digital fitness metrics along a plurality of dimensions using the plurality of digital maturity parameters; assigning, by the computing device, a weight to each the plurality of digital maturity parameters across at least one of the plurality of digital dimensions; computing, by the computing device, a plurality of dimension scores for the plurality of digital dimensions based on the weight assigned to each of the plurality of digital maturity parameters; and computing, by the computing device, a digital fitness score for the organization based on the plurality of dimension scores.

In another embodiment, a computing device for determining digital maturity of an organization is disclosed. The enterprise network device includes a processor; and a memory communicatively coupled to the processor, wherein the memory stores processor instructions, which, on execution, causes the processor to extract a plurality of digital maturity parameters; create a plurality of digital fitness metrics along a plurality of dimensions using the plurality of digital maturity parameters; assign a weight to each the plurality of digital maturity parameters across at least one of the plurality of digital dimensions; compute a plurality of dimension scores for the plurality of digital dimensions based on the weight assigned to each of the plurality of digital maturity parameters; and compute a digital fitness score for the organization based on the plurality of dimension scores.

In yet another embodiment, a non-transitory computer-readable storage medium having stored thereon, a set of computer-executable instructions causing a computer comprising one or more processors to perform steps comprising: extracting, by a computing device, a plurality of digital maturity parameters; creating, by the computing device, a plurality of digital fitness metrics along a plurality of dimensions using the plurality of digital maturity parameters; assigning, by the computing device, a weight to each the plurality of digital maturity parameters across at least one of the plurality of digital dimensions; computing, by the computing device, a plurality of dimension scores for the plurality of digital dimensions based on the weight assigned to each of the plurality of digital maturity parameters; and computing, by the computing device, a digital fitness score for the organization based on the plurality of dimension scores.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of a system for measuring digital maturity of an organization, in accordance with an embodiment.

FIG. 2 is a block diagram illustrating various modules in a memory of a computing device configured to measure digital maturity of an organization, in accordance with an embodiment.

FIG. 3 illustrates a flowchart of a method for measuring digital fitness score of an organization, in accordance with an embodiment.

FIG. 4 illustrates a flowchart of a method for determining digital maturity of an organization, in accordance with another embodiment.

FIG. 5 illustrates a block diagram of an exemplary computer system for implementing various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

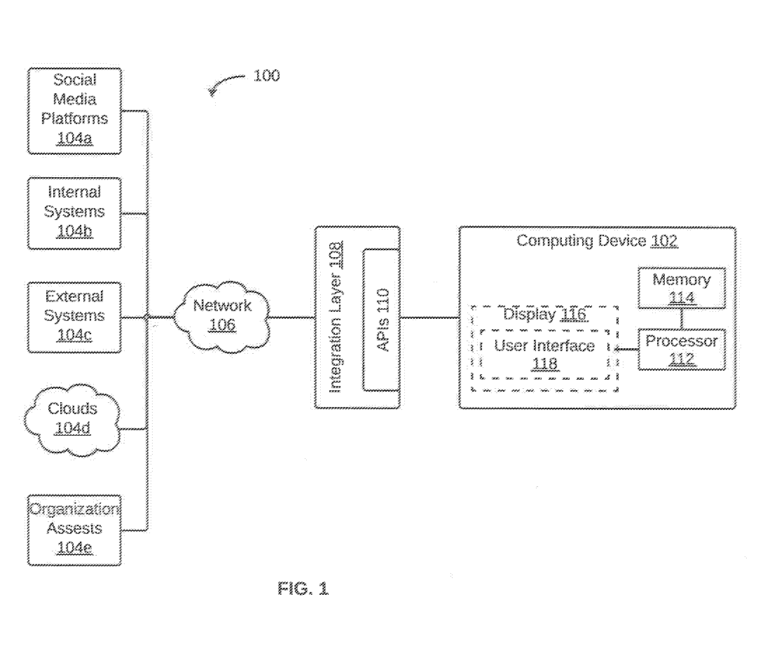

Additional illustrative embodiments are listed below. In one embodiment, a system 100 for determining digital maturity of an organization is illustrated in FIG. 1. System 100 includes a computing device 102 that communicates with one or more of social media platforms 104a, internal system 104b, external system 104c, clouds 104d, or organization assets 104e. These are collectively referred to as a plurality of system of records 104. Social media platforms 104a, for example, may include, but are not limited to Facebook® or Twitter®. Internal systems 104b are located within the organization and may include, but are not limited to Enterprise Resource Planning (ERP) systems, data warehouse systems or other internal data repositories. External systems 104c are similar to internal systems 104b, the only difference being that they are located outside the organization. Clouds 104d, for example, may be provided by Amazon®, Microsoft®, Google®, IBM®, Salesforce®, or by any other private data center. Lastly, organization assets 104e depend on the nature and characteristics of the organization and may include various IT and non-IT assets utilized by the organization.

The communication of computing device 102 with plurality of system of records 104 is enabled through a network 106, which may be a wired or a wireless network. Examples of network 106 may include, but are not limited to the Internet, Wireless Local Area Network (WLAN), Wi-Fi, Long Term Evolution (LTE), Worldwide Interoperability for Microwave Access (WiMAX), and General Packet Radio Service (GPRS).

An integration layer 108 (which is an engine) facilitates seamless pull of data from plurality of system of records 104, via network 106. Integration layer 108 may be built using service oriented architecture and implements key architecture, for example, Enterprise Service Bus (ESB) that facilitates communication of plurality of system of records 104 with computing device 102 and other systems (not shown in FIG. 1). Additionally, integration layer 108 includes multiple software based on the type of system of records (for example, whether internal or external to the organization) required to be integrated with computing device 102. By way of an example, ESB may be used for integration with internal systems 104b, a cloud broker for integration with clouds 104d, and a Business to Business (B2B) gateway for integration with external systems 104c. Integration layer 108 also include Application Programming Interfaces (APIs) 110 associated with each of these software, in order to facilitate communication with computing device 102.

Computing device 102 receives data that is pulled from plurality of system of record 104 from integration layer 108, via APIs 110. Thereafter, a processor 112 in computing device 102 processes this data to determine digital maturity of the organization. Processor 112 is communicatively coupled to a memory 114, which may be a non-volatile memory or a volatile memory. Examples of non-volatile memory, may include, but are not limited to a flash memory, a Read Only Memory (ROM), a Programmable ROM (PROM), Erasable PROM (EPROM), and Electrically EPROM (EEPROM) memory. Examples of volatile memory may include, but are not limited Dynamic Random Access Memory (DRAM), and Static Random-Access memory (SRAM).

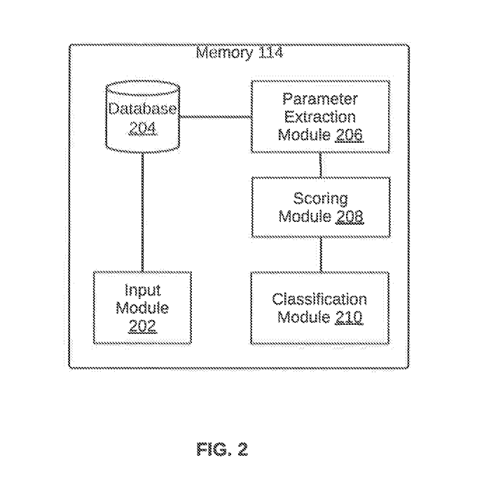

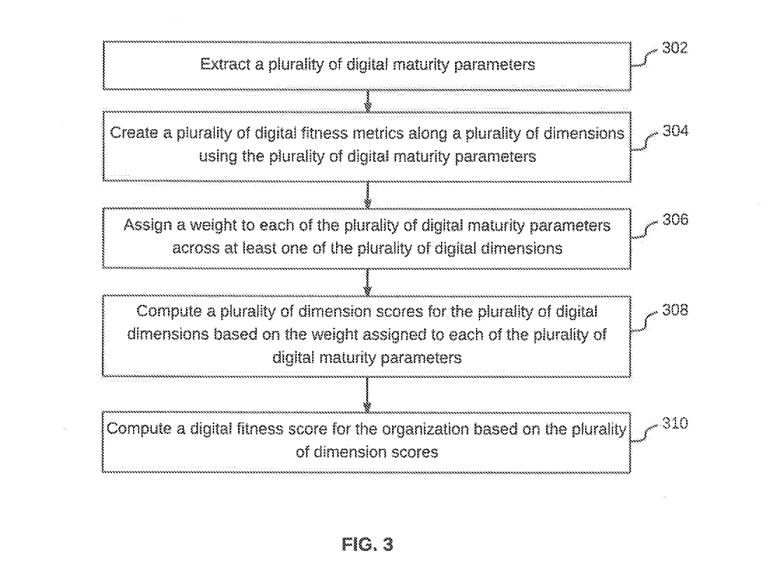

Memory 114 further includes various modules that enable determining digital fitness readings for the organization in order to arrive at final assessment ratings and provide key insights into what could be done to improve these assessment ratings. This is explained in detail in conjunction with FIG. 2. Computing device 102 may further include a display 116 having a User Interface (UI) 118 that may act as a portal and is used by users (key stakeholders) to provide a plurality of digital maturity parameters that influence the digital maturity assessment. UI 118 may provide forms that may be used to capture the plurality of digital maturity parameters in a structured format. This is further explained in detail in conjunction with FIG. 3. Display 116 may further be used to display and share results of digital maturity assessment of the organization with consumers. The consumers may be stakeholders that are internal or external to the organization. The internal consumers may include, but are not limited to strategists, design thinkers, finance, sales, or human resources. The external consumers may include, but are not limited to channel partners, suppliers, customers, end consumers, buyers, or market consultants.

Referring to FIG. 2, a block diagram depicting various modules in memory 114 of computing device 102 configured to measure digital maturity of the organization is illustrated, in accordance with an embodiment. Memory 114 includes an input module 202, a database 204, a parameter extraction module 206, a scoring module 208, and a classification module 210.

Input module 202 receives a user's (stakeholder) login details or credentials via UI 118 in order to verify the user and subsequently provide access to computing device 102. Input module 202 thereafter receives a plurality of digital maturity parameters provided by the user via UI 118 and/or based on data pulled from plurality of system of records 104. The plurality of digital maturity parameters may include one or more primary digital maturity parameters and one or more secondary digital maturity parameters. This is further explained in detail in conjunction with FIG. 3. Input module 202 stores the received data in a database 204. Storing the plurality of digital maturity parameters in database 204 enables running simulations with multiple data combinations in order to visualize the assessment of digital maturity of the organization.

Parameter extraction module 206 extracts the plurality of digital maturity parameters from database 204 and creates a plurality of digital fitness metrics. The plurality of digital fitness metrics may be aligned to one or more of a digital strategy, a digital design, or a digital technology. The plurality of digital fitness metrics are created along a plurality of digital dimensions, which may include, but are not limited to a digital interaction dimension, a digital integration dimension, and a digital insight dimension. This is further explained in detail in conjunction with FIG. 3. Thereafter, scoring module 208 assigns a weight to each of the plurality of digital maturity parameters across one or more of the plurality of digital dimensions.

Once weights have been assigned to each of the plurality of digital maturity parameters, scoring module 208 computes a plurality of dimension scores for the plurality of digital dimensions. When the plurality of digital dimensions include the digital interaction dimension, the digital integration dimension, and the digital insight dimension, a dimension score is computed for each of these dimensions. In other words, scoring module 208 computes an interaction dimension score, an integration dimension score, and an insight dimension score. Each of these dimension scores is computed as a weighted average of the primary and secondary digital maturity parameters based on the weights assigned for a respective digital dimension. Thereafter, scoring module 208 computes a digital fitness score for the organization based on the plurality of dimension scores, which may be an average of the plurality of dimension scores. This is further explained in detail in conjunction with FIG. 3.

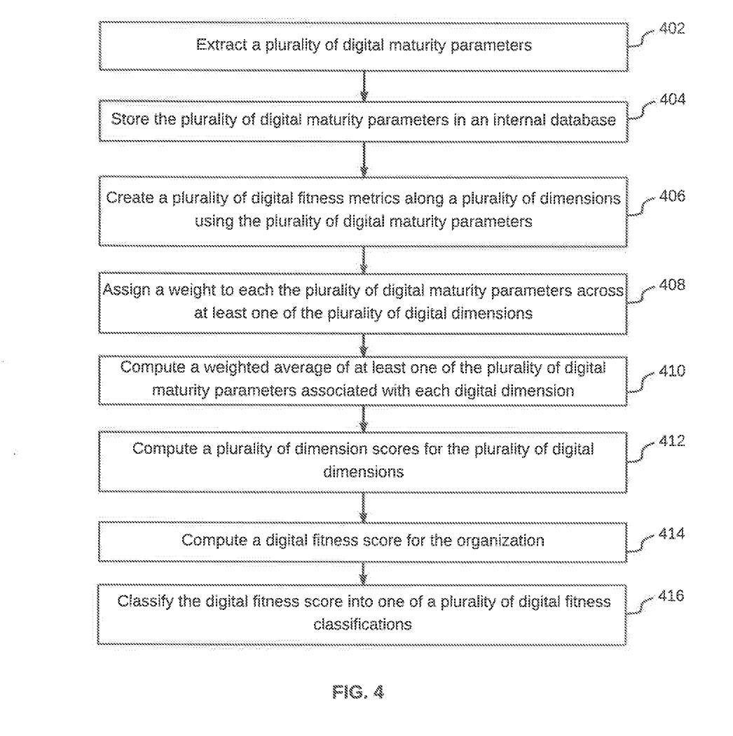

Classification module 210 classifies the digital fitness score into one of a plurality of digital maturity classifications. The plurality of digital maturity classifications are defined based on industry type of the organization and a predefined score scale created for the industry type. This is further explained in detail in conjunction with FIG. 4.

Referring now to FIG. 3, a flowchart for computing a digital fitness score for an organization is illustrated, in accordance with an embodiment. To compute the digital fitness score and to access computing device 102, a user (who is a stakeholder in the organization) may first provide his/her login details or credentials via UI 118. Based on a profile associated with the user, computing device 102 provides relevant access to the user and thereafter prompts the user to provide information based on the roles within value chain of the industry associated with the organization. Once the user has access to computing device 102, the user may provide a plurality of digital maturity parameters through one or more forms provided via UI 118. The plurality of digital maturity parameters are related to the product, process, and personnel associated with the organization. The plurality of digital maturity parameters may include one or more primary digital maturity parameters and one or more secondary digital maturity parameters. In an embodiment, the one or more forms provided via UI 118 may have separate columns for primary and secondary digital maturity parameters, so that the user can easily specify and differentiate between the provided digital maturity parameters.

Alternatively, or additionally, computing device 102 may automatically extract the plurality of digital maturity parameters from one or more data sources, i.e., one or more of plurality of system of records 104 via integration layer 108. In this case, the user may manually select one or more system of records for data retrieval. In an embodiment, after the user has provided his/her login credential, the user may select whether he/she would manually provide digital maturity parameters via UI 116 or would opt for automatic retrieval from one or more of plurality of system of records 104.

To automatically retrieve the plurality of digital maturity parameters from one or more of plurality of system of records 104, computing device 102 sends a request to a respective software in integration layer 108 (discussed in FIG. 1). By way of an example, the user may select clouds 104d for retrieving digital maturity parameters. In this case, computing device 102 sends a request to the cloud broker software in integration layer 108. Computing device 102 stores the plurality of digital maturity parameters in database 204 for further analysis to determine digital maturity of the organization. Database 204 is used irrespective of whether the user provides plurality of digital maturity parameters or these parameters are automatically retrieved from one or more of plurality of system of records 104.

At step 302, computing device 102 extracts the plurality of digital maturity parameters from database 204. Alternatively, computing device 102 may directly extract the plurality of digital maturity parameters from one or more of plurality of system of records 104. Using the plurality of digital maturity parameters, computing device 102, at step 304, creates a plurality of digital fitness metrics. The plurality of digital fitness metrics may be aligned to a digital strategy, a digital design, and a digital technology associated with the organization. The digital strategy may be a business strategy that keeps the digital users at the focal of the organization. The digital design may bring the design thinking across each aspect of business to the digital user's touch points. Lastly, the digital technology may be the new age technologies that help drive the digital design and the digital strategy initiatives. A metrics may be a standard of measurement based on which efficiency, performance, progress, or quality of a plan, process, employee or product associated with the organization may be assessed.

The plurality of digital fitness metrics are created along a plurality of digital dimensions. The plurality of digital dimensions may include, but are not limited to a digital interaction dimension, a digital integration dimension, and a digital insight dimension. The digital interaction dimension is the intersection of the digital strategy and the digital design, which enables a digital user experience design with strategy. The digital integration dimension is the intersection of the digital technology and the digital design, which enables a digital user experience design with technology. Lastly, the digital insight dimension is the intersection of the digital strategy and the digital technology, which enables digital users to gain insights through technology and strategy. Each of the plurality of digital fitness metrics may be categorized into one of a primary category or a secondary category based on its impact to the organization's cost revenue and/or operating efficiency.

At step 306, computing device 102 assigns a weight to each of the plurality of digital maturity parameters across one or more of the plurality of digital dimensions. In other words, a given digital maturity parameter would be assigned multiple weights based on the number of digital dimensions available. By way of an example, when there are three digital dimensions, i.e., a digital interaction dimension, a digital integration dimension, and a digital insight dimension, then a given digital maturity parameter would be assigned three different weights, one for each of these three digital dimensions. As the plurality of digital maturity parameters include one or more primary digital maturity parameters and one or more secondary digital maturity parameters, separated weights are assigned to primary and secondary digital maturity parameters.

Once weights have been assigned to each of the plurality of digital maturity parameters, computing device 102, at step 308, computes a plurality of dimension scores for the plurality of digital dimensions based on the weight assigned to each of the plurality of digital maturity parameters. In other words, a dimension score is computed for each digital dimension. When the plurality of digital dimensions include the digital interaction dimension, the digital integration dimension, and the digital insight dimension, a dimension score is computed for each of these dimensions. To compute a dimension score, each digital maturity parameter is represented along a predefined parameter value scale. By way of an example, the predefined parameter value scale may range from 1 to 10. Thus, each digital maturity parameter would be assigned a value that is selected from 1 to 10.

To compute an interaction dimension score, one or more primary digital fitness metrics created for the digital interaction dimension are used. These primary digital fitness metrics includes primary and secondary digital maturity parameters, which are chosen by the organization for being critical to adjudge digital readiness of the organization along the digital interaction dimension. By way of an example, for the digital interaction dimension, in case of an automobile manufacturing organization, primary and/or secondary digital maturity parameters may include, but are not limited to customer satisfactions score, word of recommendation score, customer experience, digital engagement score, digital marketing score, digital commerce store, or in-store experience.

The interaction dimension score may be computed as a weighted average of the primary and secondary digital maturity parameters based on the weights assigned for the digital interaction dimension at step 306. In an exemplary embodiment, the interaction dimension score may be computed using equation 1 given below:

$$ICS = \frac{( {x}_{1} \frac{( {Σ}_{i}^{{p}_{1}} {P}_{SDi} )}{{p}_{1}} ) + ( {y}_{1} \frac{( {Σ}_{i}^{{s}_{1}} {S}_{SDi} )}{{s}_{1}} )}{( {x}_{1} + {y}_{1} )} \qquad ( 1 )$$

where,
ICS is the interaction dimension score;
P_{SDi} represents primary digital maturity parameters for the digital interaction dimension;
P₁ is the total number of primary digital maturity parameters extracted for the digital interaction dimension;
x₁ is the weight assigned to a primary digital maturity parameter;
S_{SDi} represents secondary digital maturity parameters for the digital interaction dimension;
S₁ is the total number of secondary digital maturity parameters for the digital interaction dimension;
y₁ is the weight assigned to a secondary digital maturity parameter.

To compute an integration dimension score, one or more primary digital fitness metrics created for the digital integration dimension are used. These primary digital fitness metrics includes primary and secondary digital maturity parameters, which are chosen by the organization for being critical to adjudge digital readiness of the organization along the digital integration dimension. By way of an example, for the digital integration dimension, in case of an automobile manufacturing organization, primary and/or secondary digital maturity parameters may include, but are not limited to field sales adoption of digital engagement systems, digital supply chain, digital procurement, asset tracking, inventory management and improvement, augmented and virtual reality, cognitive processing, autonomous vehicles, or omni-channel experience.

The integration dimension score may be computed as a weighted average of the primary and secondary digital maturity parameters based on the weights assigned for the digital integration dimension at step 306. In an exemplary embodiment, the integration dimension score may be computed using equation 2 given below:

$$IGS = \frac{( {x}_{2} \frac{( {Σ}_{i}^{{p}_{2}} {P}_{DTi} )}{{p}_{2}} ) + ( {y}_{2} \frac{( {Σ}_{i}^{{s}_{2}} {S}_{DTi} )}{{s}_{2}} )}{( {x}_{2} + {y}_{2} )} \qquad ( 2 )$$

where,
IGS is the integration dimension score;
P_{OTi} represents primary digital maturity parameters for the digital integration dimension;
P₂ is the total number of primary digital maturity parameters extracted for the digital integration dimension;
x₂ is the weight assigned to a primary digital maturity parameter;
S_{DTi} represents secondary digital maturity parameters for the digital integration dimension;
S₂ is the total number of secondary digital maturity parameters for the digital integration dimension;
y₂ is the weight assigned to a secondary digital maturity parameter.

To compute an insight dimension score, one or more primary digital fitness metrics created for the digital insight dimension are used. These primary digital fitness metrics includes primary and secondary digital maturity parameters, which are chosen by the organization for being critical to adjudge digital readiness of the organization along the digital insight dimension. By way of an example, for the digital insight dimension, in case of an automobile manufacturing organization, primary and/or secondary digital maturity parameters may include, but are not limited to digital employee experience, workforce management, sales enhancement, or business process modelling.

The insight dimension score may be computed as a weighted average of the primary and secondary digital maturity parameters based on the weights assigned for the digital insight dimension at step 306. In an exemplary embodiment, the insight dimension score may be computed using equation 3 given below:

$$INS = \frac{( {x}_{3} \frac{( {Σ}_{i}^{{p}_{3}} {P}_{STi} )}{{p}_{3}} ) + ( {y}_{3} \frac{( {Σ}_{i}^{{s}_{3}} {S}_{STi} )}{{s}_{3}} )}{( {x}_{3} + {y}_{3} )} \qquad ( 3 )$$

where,
INS is the insight dimension score;
P_{STi} represents primary digital maturity parameters for the digital insight dimension;
P₃ is the total number of primary digital maturity parameters extracted for the digital insight dimension;
x₃ is the weight assigned to a primary digital maturity parameter;
S_{STi} represents secondary digital maturity parameters for the digital insight dimension;
S₃ is the total number of secondary digital maturity parameters for the digital insight dimension;
y₃ is the weight assigned to a secondary digital maturity parameter.

Thereafter, computing device 102, at step 310, computes a digital fitness score for the organization based on the plurality of dimension scores. A customizable dashboard may be provided for measurement of digital fitness scores. The digital fitness score may be an average of the plurality of dimension scores and may be computed using the equation 4 given below:

$$DFS = \frac{ICS + IGS + INS}{3} \qquad ( 4 )$$

where,
DFS is the digital fitness score for the organization;
ICS is the interaction dimension score;
IGS is the integration dimension score; and
INS is the insight dimension score.

In an embodiment, weights may be assigned to each dimension score, based on relevance of that dimension to the organization for which the digital fitness score is being computed. In this case, a weighted average of the dimension scores may be computed to determine digital fitness score for the organization. The digital fitness score may be classified into one of a plurality of digital maturity classifications. This is further explained in detail in conjunction with FIG. 4.

The digital fitness score calculated for the organization and subsequent classification into a digital maturity classification may be published as API's for consumption by external agencies and internal stakeholders based on their respective access permissions. Along with the scores and classifications, key insights that include suggested measures or steps for improvement of digital maturity of the organization may also be provided. The results would be exposed in various formats for consumption by multiple consumers. The consumers may be stakeholders that are internal or external to the organization. The internal consumers may include, but are not limited to strategists, design thinkers, finance, sales, or human resources. The external consumers may include, but are not limited to channel partners, suppliers, customers, end consumers, buyers, or market consultants.

The above discussed method and system thus help the organization to evaluate its digital fitness or maturity and determine the improvements that are required to accomplish the desired digital maturity goals and improve profitability for the organization.

Referring now to FIG. 4, a flowchart of a method for determining digital maturity of an organization is illustrated, in accordance with an embodiment. At step 402, computing device 102 extracts a plurality of digital maturity parameters. Thereafter, at step 404, computing device 102 stores the plurality of digital maturity parameters in internal database 204. At step 406, computing device 102 creates a plurality of digital fitness metrics along a plurality of dimensions using the plurality of digital maturity parameters. This has been explained in detail in conjunction with FIG. 3.

At step 408, computing device 102 assigns a weight to each the plurality of digital maturity parameters across one or more of the plurality of digital dimensions. Thereafter, at step 410, computing device 102 computes a weighted average of one or more of the plurality of digital maturity parameters associated with each digital dimension. Based on this, at step 412, computing device 102 computes a plurality of dimension scores for the plurality of digital dimensions. At step 414, computing device 102 computes a digital fitness score for the organization based on the plurality of dimension scores. This has been explained in detail in conjunction with FIG. 3.

At step 416, computing device 102 classifies the digital fitness score into one of a plurality of digital maturity classifications. The plurality of digital maturity classifications are defined based on industry type of the organization and a predefined score scale created for the industry type. The predefined score scale may range from a value of 1 to 10. In an exemplary embodiment, the plurality of digital maturity classifications includes champions, challengers, aspirants, and laggards. Each digital maturity classification may have a predefined range, for example, when the digital fitness score ranges from 0 to 6, the organization's digital maturity is classified as laggards, when the digital fitness score ranges from 6 to 8, the organization's digital maturity is classified as aspirants, when the digital fitness score ranges from 8 to 9, the organization's digital maturity is classified as challengers, and when the digital fitness score ranges from 9 to 10, the organization's digital maturity is classified as champions.

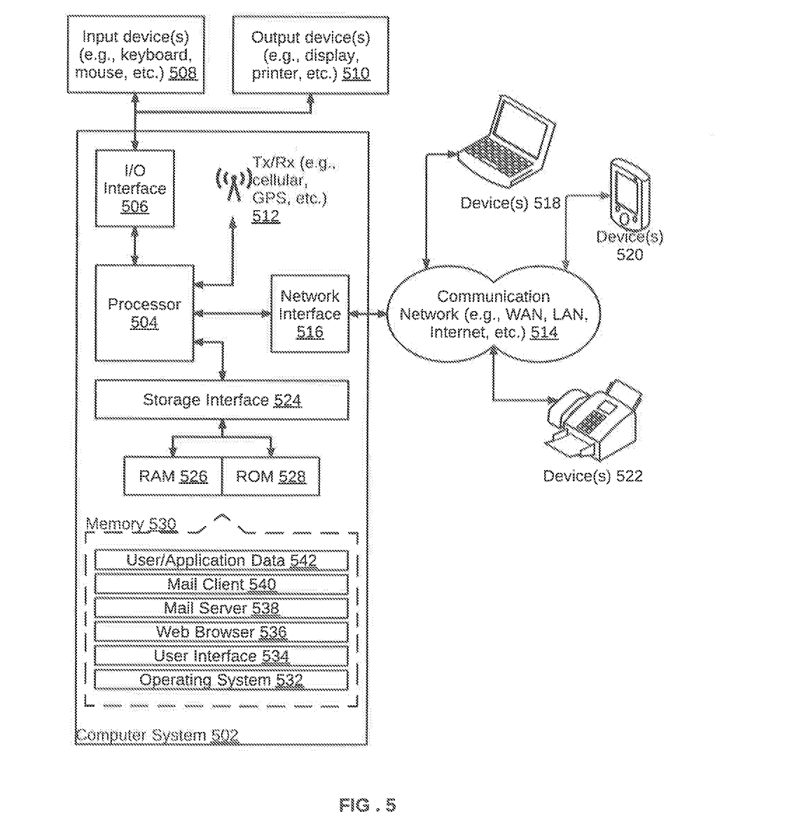

FIG. 5 is a block diagram of an exemplary computer system for implementing various embodiments. Computer system 502 may comprise a central processing unit (“CPU” or “processor”) 504. Processor 504 may comprise at least one data processor for executing program components for executing user- or system-generated requests. A user may include a person, a person using a device such as such as those included in this disclosure, or such a device itself. Processor 504 may include specialized processing units such as integrated system (bus) controllers, memory management control units, floating point units, graphics processing units, digital signal processing units, etc. Processor 504 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 504 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 504 may be disposed in communication with one or more input/output (I/O) devices via an I/O interface 506, I/O interface 506 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMF), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 506, computer system 502 may communicate with one or more I/O devices. For example, an input device 508 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 510 may be a printer, fax machine, video display (e.g., cathode ray tube (CRT), liquid crystal display (LCD), light-emitting diode (LED), plasma, or the like), audio speaker, etc. In some embodiments, a transceiver 512 may be disposed in connection with processor 504. Transceiver 512 may facilitate various types of wireless transmission or reception. For example, transceiver 512 may include an antenna operatively connected to a transceiver chip (e,g., TEXAS® INSTRUMENTS WILINK WL1238® transceiver, BROADCOM® BCM4550IUB8® transceiver, INFINEON TECHNOLOGIES® X-GOLD 618-PMB9800® transceiver, or the like), providing IEEE 802.11a/b/g/n, Bluetooth FM, global positioning system (GPS), 2G/3G HSDPA/HSUPA communications, etc.

In some embodiments, processor 504 may be disposed in communication with a communication network 514 via a network interface 516. Network interface 516 may communicate with communication network 514. Network interface 516 may employ connection protocols including, without limitation, direct connect, Ethernet (e.g., twisted pair 50/500/5000 Base T), transmission control protocol/internet protocol (TCP/IP), token ring, IEEE 802.11a/b/g/n/x, etc. Communication network 514 may include, without limitation, a direct interconnection, local area network (LAN), wide area network (WAN), wireless network (e.g., using Wireless Application Protocol), the Internet, etc. Using network interface 516 and communication network 514, computer system 502 may communicate with devices 518, 520, and 522. These devices may include, without limitation, personal computer(s), server(s), fax machines, printers, scanners, various mobile devices such as cellular telephones, smartphones (e.g., APPLE® IPHONE® smartphone, BLACKBERRY® smartphone, ANDROID® based phones, etc.), tablet computers, eBook readers (AMAZON® KINDLE® ereader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 502 may itself embody one or more of these devices.

In some embodiments, processor 504 may be disposed in communication with one or more memory devices (e.g., RAM 526, ROM 528, etc.) via a storage interface 524. Storage interface 524 may connect to memory 530 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 530 may store a collection of program or database components, including, without limitation, an operating system 532, user interface application 534, web browser 536, mail server 538, mail client 540, user/application data 542 (e.g., any data variables or data records discussed in this disclosure), etc. Operating system 532 may facilitate resource management and operation of computer system 502. Examples of operating systems 532 include, without limitation, APPLE® MACINTOSH® OS X platform, UNIX platform, Unix-like system distributions (e.g., Berkeley Software Distribution (BSD), FreeBSD, NetBSD, OpenBSD, etc.), LINUX distributions (e.g., RED HAT®, UBUNTU®, KUBUNTU®, etc.), IBM® OS/2 platform, MICROSOFT® WINDOWS® platform (XP, Vista/7/8, etc.), APPLE® IOS® platform, GOOGLE® ANDROID® platform, BLACKBERRY® OS platform, or the like. User interface 534 may facilitate display, execution, interaction, manipulation, or operation of program components through textual or graphical facilities. For example, user interfaces may provide computer interaction interface elements on a display system operatively connected to the computer system 502, such as cursors, icons, check boxes, menus, scrollers, windows, widgets, etc. Graphical user interfaces (GUIs) may be employed, including, without limitation, Apple® Macintosh® operating systems' AQUA® platform, IBM® OS/2® platform, MICROSOFT® WINDOWS® platform (e.g., AERO® platform, METRO® platform, etc.), UNIX X-WINDOWS, web interface libraries (e.g., ACTIVEX® platform, JAVA® programming language, JAVASCRIPT® programming language, AJAX® programming language, HTML, ADOBE® FLASH® platform, etc.), or the like.

In some embodiments, computer system 502 may implement a web browser 536 stored program component. Web browser 536 may be a hypertext viewing application, such as MICROSOFT® INTERNET EXPLORER® web browser, GOGGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APis), etc. In some embodiments, computer system 502 may implement a mail server 538 stored program component. Mail server 538 may be an Internet mail server such as MICROSOFT® EXCHANGE® mall server, or the like. Mail server 538 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, PYTHON® programming language, WebObjects, etc. Mail server 538 may utilize communication protocols such as Internet message access protocol (IMAP), messaging application programming interface (MAPI), Microsoft Exchange, post office protocol (POP), simple mail transfer protocol (SMTP), or the like. In some embodiments, computer system 502 may implement a mail client 540 stored program component. Mail client 540 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, computer system 502 may store user/application data 542, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text the (e.g., XML), table, or as object-oriented databases (e.g., using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Various embodiments provide method and device for determining digital maturity of an organization. The method and device enable digital transformation journey of the organization by providing an exact quantitative measurement of the digital maturity of the organization. The exact quantitative measurement also helps stakeholders to access digital maturity status of the organization and plan the digital roadmap ahead. The method is not restricted to a particular industry and is applicable for all types of industries and their segments. Additionally, the digital maturity parameters considered for determining digital maturity are not restricted and consider lots of input for calculating the digital maturity level of any organization. As a result, the assessment results are more elaborate and accurate.

The specification has described method and device for determining digital maturity of an organization. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for determining digital maturity of an organization, the method comprising:
extracting, by a computing device, a plurality of digital maturity parameters;
creating, by the computing device, a plurality of digital fitness metrics along a plurality of digital dimensions using the plurality of digital maturity parameters;
assigning, by the computing device, a weight to each the plurality of digital maturity parameters across at least one of the plurality of digital dimensions;
computing, by the computing device, a plurality of dimension scores for the plurality of digital dimensions based on the weight assigned to each of the plurality of digital maturity parameters; and
computing, by the computing device, a digital fitness score for the organization based on the plurality of dimension scores.

2. The method of claim 1, wherein the plurality of digital dimensions comprises a digital interaction dimension, a digital integration dimension, and a digital insight dimension.

3. The method of claim 1, wherein computing a dimension score from the plurality of dimension scores for a digital dimension from the plurality of digital dimensions comprises computing a weighted average of at least one of the plurality of digital maturity parameters associated with the digital dimension.

4. The method of claim 3 further comprising representing each of the at least one digital maturity parameter along a predefined parameter value scale.

5. The method of claim 1, wherein the digital fitness score is an average of the plurality of dimension scores.

6. The method of claim 1 further comprising defining a plurality of digital maturity classifications based on industry type of the organization and a predefined score scale created for the industry type.

7. The method of claim 6 further comprising classifying the digital fitness score into one of the plurality of digital maturity classifications.

8. The method of claim 1, wherein the plurality of digital maturity parameters comprises at least one primary digital maturity parameter and at least one secondary digital maturity parameter, wherein the plurality of digital maturity parameters are automatically extracted from at least one data source.

9. The method of claim 1, wherein the plurality of digital maturity parameters are provided by at least one stakeholder via at least one form.

10. The method of claim 1 further comprising storing the plurality of digital maturity parameters in an internal database.

11. A computing device for determining digital maturity of an organization, the computing device comprising:
a processor; and
a memory communicatively coupled to the processor, wherein the memory stores processor instructions, which, on execution, causes the processor to:
extract a plurality of digital maturity parameters;
create a plurality of digital fitness metrics along a plurality of digital dimensions using the plurality of digital maturity parameters;
assign a weight to each the plurality of digital maturity parameters across at least one of the plurality of digital dimensions;
compute a plurality of dimension scores for the plurality of digital dimensions based on the weight assigned to each of the plurality of digital maturity parameters; and
compute a digital fitness score based on the plurality of dimension scores.

12. The computing device of claim 11, wherein the plurality of digital dimensions comprises a digital interaction dimension, a digital integration dimension, and a digital insight dimension.

13. The computing device of claim 11, wherein to compute a dimension score from the plurality of dimension scores for a digital dimension from the plurality of digital dimensions, the processor instructions further cause the processor to compute a weighted average of at least one of the plurality of digital maturity parameters associated with the digital dimension.

14. The computing device of claim 13, wherein the processor instructions further cause the processor to represent each of the at least one digital maturity parameter along a predefined parameter value scale.

15. The computing device of claim 11, wherein the digital fitness score is an average of the plurality of dimension scores.

16. The computing device of claim 11, wherein the processor instructions further cause the processor to define a plurality of digital maturity classifications based on industry type of the organization and a predefined score scale created for the industry type.

17. The computing device of claim 16, wherein the processor instructions further cause the processor to classify the digital fitness score into one of the plurality of digital maturity classifications.

18. The computing device of claim 11, wherein the plurality of digital maturity parameters comprises at least one primary digital maturity parameter and at least one secondary digital maturity parameter, wherein the plurality of digital maturity parameters are automatically extracted from at least one data source.

19. The computing device of claim 1, wherein the plurality of digital maturity parameters are provided by at least one stakeholder via at least one form.

20. A non-transitory computer-readable storage medium having stored thereon, a set of computer-executable instructions causing a computer comprising one or more processors to perform steps comprising:
extracting, by a computing device, a plurality of digital maturity parameters;
creating, by the computing device, a plurality of digital fitness metrics along a plurality of digital dimensions using the plurality of digital maturity parameters;
assigning, by the computing device, a weight to each the plurality of digital maturity parameters across at least one of the plurality of digital dimensions;
computing, by the computing device, a plurality of dimension scores for the plurality of digital dimensions based on the weight assigned to each of the plurality of digital maturity parameters; and
computing, by the computing device, a digital fitness score based on the plurality of dimension scores.
